(19) United States
(12) Patent Application Publication
(10) Pub. No.: US 2013/0040194 A1
(43) Pub. Date: Feb. 14, 2013

(54) LAYERED COMPOSITE MATERIAL FOR USE IN A REDOX FLOW BATTERY

(71) Applicants: Oswin Öttinger, Meitingen (DE); Rainer Schmitt, Augsburg (DE); Jürgen Bacher, Wertingen (DE); Sylvia Mechen, Meitingen (DE); Bastian Hudler, Rain (DE)

(72) Inventors: Oswin Öttinger, Meitingen (DE); Rainer Schmitt, Augsburg (DE); Jürgen Bacher, Wertingen (DE); Sylvia Mechen, Meitingen (DE); Bastian Hudler, Rain (DE)

(73) Assignee: SGL CARBON SE, WIESBADEN (DE)

(21) Appl. No.: 13/520,273

(22) PCT Filed: Dec. 31, 2010
(86) PCT No.: PCT/EP10/70974

§ 371 Date: Sep. 28, 2012

(30) Foreign Application Priority Data
Dec. 31, 2009 (DE) 10 2009 055 440.8
Dec. 31, 2009 (DE) 10 2009 055 441.6
Dec. 31, 2009 (DE) 10 2009 055 442.4
Dec. 31, 2009 (DE) 10 2009 055 443.2
Dec. 31, 2009 (DE) 10 2009 055 444.0
Feb. 16, 2010 (DE) 10 2010 002 000.1
Feb. 26, 2010 (DE) 10 2010 002 434.1
Mar. 17, 2010 (DE) 10 2010 002 989.0
Sep. 20, 2010 (DE) 10 2010 041 085.3
Sep. 30, 2010 (DE) 10 2010 041 822.6
Oct. 29, 2010 (US) 12/915340

(51) Int. Cl. H01M 4/02; H01M 2/00; B32B 38/00; B32B 9/00; B32B 27/04

(52) U.S. Cl. 429/210; 428/221; 428/323; 428/339; 442/294; 442/304; 442/394; 442/320; 442/1; 428/327; 156/245; 29/623.1

(57) ABSTRACT

A layered composite material which is suitable, in particular, for use in a redox flow battery, contains at least one layer of a textile fabric and at least one graphite-containing molded body which is obtained by a method in which graphite particles are mixed with at least one solid organic additive to form a mixture and the thus obtained mixed is then compressed.

The present invention relates to a layered composite material suitable in particular for use in a redox flow battery, containing at least one layer of a textile fabric and at least one graphite-containing molded body. The present invention further relates to a method for producing such a layered composite material, the use of such a layered composite material, a bipolar plate and a redox flow battery.

A redox flow battery comprises an electrochemical cell which is constructed from two half-cells each filled with a liquid electrolyte and separated from one another by an ion-conducting membrane in which respectively one electrode is provided. In this case, the electrolyte consists of a salt or salts dissolved in a solvent, where inorganic or organic acids are usually used as solvents and for example, titanium, iron, chromium, vanadium, cerium, zinc, bromine and sulphur salts are used as salts or redox pairs.

In this case, the ion-conducting membrane provides for charge balancing but at the same time prevents mass transfer between the two half-cells. Whilst when charging the redox flow battery, the cations of the salt dissolved in the electrolyte are reduced at the electrode provided in the negative half-cell, the anions of the salt dissolved in the electrolyte are oxidized at the electrode provided in the positive half-cell. As a result, during the charging or during the storage process electrons flow from the positive half-cell into the negative half-cell whereas during a discharging process the electrons flow in the reverse direction.

In these redox flow batteries, graphite electrodes are usually used as electrodes because these have a large electrochemical potential window. In order to achieve the highest possible specific power, graphite felts having a comparatively high specific surface area are frequently used as graphite electrodes.

When individual redox flow batteries or redox flow cells are connected in series with one another in the form of a cell stack, the individual cells are typically separated from one another by bipolar plates. As a result of the good chemical resistance and the high electrical conductivity of graphite, graphite plates or graphite films are frequently used for this purpose. In order to achieve a compact structure, the electrodes constructed of graphite felt are each attached to the two opposite outer surfaces of the bipolar plates and connected to the bipolar plate to form a layered composite material or laminate.

These layered composite materials comprising a bipolar plate and graphite felts applied to both outer surfaces thereof must fulfil a number of requirements. In addition to the good chemical resistance and the high electrical conductivity, or a low electrical resistance, already mentioned previously the bipolar plate of the layered composite material must be characterized by a high tensile strength and by a low permeability primarily for liquids. On the other hand, the graphite felts must have the highest possible permeability to the electrolytes in order to achieve a large contact area between electrolyte and electrode and thus a high cell performance and in order to avoid or at least minimize any pressure drop. In addition, the graphite felts must have a high electrical conductivity and a good chemical resistance.

In order to increase the tightness of graphite for the purpose of adjusting a low permeability of the bipolar plate for liquids, it has already been proposed to make graphite films of liquid-impregnated graphite, i.e. from graphite whose pores have at least partially been closed by liquid impregnation or melt impregnation by means of a suitable impregnating agent. For example, low-viscosity furfuryl alcohol or solvent-containing phenol resin are used as impregnating agents. Along with the tightness, the handling and the scratch resistance of the material can also be improved by impregnation.

A disadvantage of such materials produced by liquid impregnation however is that the impregnating agent is non-uniformly distributed particularly in the depth direction or z direction of the material. Whereas a high degree of impregnation and a comparatively homogeneous impregnation is thus achieved in the surface areas of the material, the inner region of the material thus impregnated located between the surface regions exhibits no or only a comparatively low or non-uniform degree of impregnation. As a result, a bipolar plate made of such a material certainly exhibits a comparatively high impermeability for liquids and gases in its surface regions due to the surface impregnation; however, in the central region located between the surface regions this is comparatively permeable which is why these bipolar plates are in need of improvement, for example for use in redox flow batteries.

It is also known to use bipolar plates produced from corresponding mixtures with graphite fractions by pressing methods (“mould to size”, “press to size”), for example, with polypropylene, polyvinylidene fluoride and phenol resin as additive. However, such bipolar plates have high absolute resistance values and a disadvantageous electrical resistance as the total of contact and transition resistance.

Another disadvantage of known layered composite materials used in a redox flow battery is that in these the adhesion and therefore the electrical contact resistance between the bipolar plate and the electrode material, i.e. the graphite felt is insufficient. These must therefore be pressed relatively strongly with one another during use by means of a frame construction, usually by 20 to 30%. As a result of the strong pressing, the felt structure is severely compressed so that the electrolyte cannot flow optimally through the felt which in particular with large electrode areas, leads to massive pressure losses and therefore to high parasitic power losses in the battery. In addition, the material relaxes with time as a result of the high pressing pressure and as a result of minimal corrosion effects at individual fibers, which is why the felt layers become detached from the bipolar plate with increasing operating time and thus the contact resistance of the layered composite material increases. Due to the additionally poor adaptability primarily of the graphite-filled plates, an additional seal between frame and bipolar plate must be provided according to the installation situation in order to prevent any escape of the electrolyte.

It is therefore the object of the present invention to provide a layered composite material which is in particular suitable for use in a redox flow battery, comprising a bipolar plate based on a graphite-containing molded body such as in particular a graphite film and at least one electrode attached thereto comprising a textile fabric, which can be manufactured simply and cost-effectively, in which the textile fabric is firmly connected permanently to the bipolar plate and in which the bipolar plate is not only characterized by a high tensile strength and by a high electrical conductivity but in particular has a particularly high impermeability to liquids and gases and a good flexibility.

According to the invention, this object is achieved by providing a layered composite material in particular for use in a redox flow battery, wherein the layered composite material contains at least one layer of a textile fabric and at least one graphite-containing molded body, wherein the graphite-containing molded body can be obtained by a method in which graphite particles are mixed with at least one solid organic additive to form a mixture and the mixture thus obtained is then compressed.

This solution is based on the surprising finding that in such a layered composite material, the molded body based on graphite functioning as the bipolar plate not only has a high degree of filling of pore-closing additive but that the pore-closing additive is additionally homogeneously distributed over all three dimensions and in particular in the depth direction of the molded body, i.e. in the z direction of the molded body. For this reason the molded body has homogeneous properties in all three dimensions and in particular also in the perpendicular plane of the molded body, i.e. in the plane perpendicular to the x-y direction or the plane in which the molded body has its longest extension, and is characterized by a high strength in the z direction and in particular also by a high electrical conductivity, a high tensile strength, a high thermal conductivity, a high temperature resistance, a good chemical resistance, a high impermeability to liquids and by a high stability and specifically in particular also when the surface pressure of the molded body is low. As a result of the homogeneous distribution of the organic additive or the organic additives over all three dimensions, it is in particular achieved that the additive is not only present in the near-surface regions of the molded body but in particular also in the inner or central region of the molded body located between the near-surface regions. This prevents the molded body from only having a high impermeability in its near-surface regions but gases or liquids are able to diffuse in the interior of the molded body. On the contrary, due to the homogeneous additive distribution a high impermeability is also achieved in the interior of the molded body in all dimensions. As a result of the low electrical resistance of the molded body, in particular the entire layered composite material also has a low electrical resistivity.

Another essential advantage of the layered composite material according to the invention is that as a result of its high impermeability primarily to liquids, the molded body contained therein can be configured to be thinner in particular for use in a redox flow battery than is the case in the bipolar plates known from the prior art. As a result the layered composite material and the entire redox flow battery can be configured to be more compact for the same power.

It is also a particular advantage compared with the molded bodies known from the prior art that the graphite-containing molded body contained in the layered composite material according to the invention can be produced rapidly, simply and cost-effectively and in particular by a continuous process in which a solid and preferably dry organic additive is added continuously by means of a screw conveyor, for example, to a gas stream containing graphite particles and thereby mixed and this mixture is then continuously guided through a roller in which the mixture is compressed.

Another essential advantage of the layered composite material according to the invention is that a particularly firm bonding of the molded body with the at least one layer of textile fabric can be achieved by the organic additive contained in the graphite-containing molded body, for example, by thermal bonding or by means of an adhesive. In particular, the organic additive allows a direct welding of the molded body filled with organic additive to the textile fabric when the textile fabric is pressed to the molded body with little contact pressure during the melting or sintering of the organic additive. Thus, the layered composite material according to the invention must be very much less strongly pressed by a frame construction during its use so that the textile fabric is not so severely compressed. For this reason the electrolyte in the layered composite material according to the invention can flow better through the textile fabric with the result that the battery efficiency can be increased when used in a redox flow battery. In addition the layered composite material according to the invention has a longer lifetime as a result because the textile fabric is not so easily detached from the molded body and thus the contact resistance of the layered composite material remains low over long operating times.

As described, the molded body contained in the layered composite material according to the invention is obtained by a method in which graphite particles are mixed with the at least one solid organic additive to form a mixture before the mixture thus obtained is then compressed. Within the framework of the present patent application, it is understood by this that in contrast to a liquid or melt impregnation, neither the graphite particles nor the additive nor the mixture containing graphite particles and additive are melted or sintered before compressing the mixture.

In principle, particles based on all known graphites, i.e. for example particles of natural graphite or of synthetic graphite can be used as graphite starting material for the molded bodies contained in the layered composite material according to the invention.

However, according to a particularly preferred embodiment of the present invention it is proposed that particles of expanded graphite are used as graphite particles. Expanded graphite is understood as graphite which, compared with natural graphite, is expanded for example, by a factor of 80 or more in the plane perpendicular to the hexagonal carbon layers. As a result of this expansion, expanded graphite is characterized by exceptionally good malleability and a good interlocking property, which is why this is particularly suitable for producing the molded body contained in the layered composite material according to the invention. As a result of its likewise high porosity, expanded graphite can also be mixed very well with particles of organic additive having a correspondingly small particle diameter and as a result of the degree of expansion, is easy to compress or compact. In order to produce expanded graphite having a worm-like structure, usually graphite such as natural graphite is mixed with an intercalation compound such as, for example nitric acid or sulphuric acid and heat-treated at an elevated temperature of, for example, 600 to 1200° C.

It is preferable to use expanded graphite which has preferably been produced from natural graphite having a mean particle diameter (d₅₀) of at least 149 μm and preferably of at least 180 μm determined in accordance with the measurement method and screen set specified in DIN 66165.

Particularly good results are obtained in this embodiment in particular using particles of expanded graphite having a degree of expansion of 10 to 1,400, preferably of 20 to 700 and particularly preferably of 60 to 100.

This substantially corresponds to expanded graphite having a bulk weight of 0.5 to 95 g/l, preferably of 1 to 25 g/l and particularly preferably of 2 to 10 g/l.

In a further development of the inventive idea, it is proposed to use graphite particles and in particular particles of expanded graphite having a mean particle diameter (d₅₀) of 150 to 3,500 μm, preferably of 250 to 2,000 μm and particularly preferably of 500 to 1,500 μm. These graphite particles can be mixed and compressed particularly well with particulate organic additives. In this case the mean diameter (d₅₀) of the graphite particles is determined in accordance with the measurement method and screen set specified in DIN 66165.

The mixture to be compressed preferably contains 50 to 99 wt. %, preferably 70 to 97 wt. % and particularly preferably 75 to 95 wt. % of graphite particles and preferably corresponding particles of expanded graphite.

According to a particularly preferred embodiment of the present invention, the molded body contained in the layered composite material according to the invention has an impermeability perpendicular to its longitudinal plane of less than 10⁻¹ mg/(s.m²), preferably of less than 10⁻² mg/(s.m²) and particularly preferably of less than 10⁻³ mg/(s.m²), measured at a surface pressure of 20 MPa with helium as gas (1 bar helium test gas internal pressure) in a measuring apparatus based on DIN 28090-1 at room temperature.

As a result of the addition of an organic additive, it is easily possible to provide the graphite-containing molded body contained in the layered composite material according to the invention so that this has a tensile strength of 10 to 35 MPa and preferably of 15 to 25 MPa measured in accordance with DIN ISO 1924-2.

In a further development of the inventive idea, it is proposed to provide in the layered composite material according to the invention a graphite-containing molded body having an electrical resistivity of less than 20 Ω.mm and preferably less than 15 Ω.mm measured in accordance with DIN 51911 with an applied load of 50 N in an area of 50 mm perpendicular to its longitudinal plane.

According to a further particularly preferred embodiment of the present invention, the mixture to be compressed or the graphite-containing molded body in the layered composite material according to the invention contains 1 to 50 wt. %, preferably 3 to 30 wt. % and particularly preferably 5 to 25 wt. % of one or more organic additives. As a result, particularly good results are achieved particularly in regard to a desired impermeability but also in regard to a high tensile strength and mechanical stability. In addition, a molded body having a very high tensile strength and having a high impermeability in particular in the z direction of the molded body is obtained. Apart from this, the addition of the organic additive facilitates the shaping and leads to a better weldability of the molded body with another graphite-containing molded body as in the layered composite material according to the invention, with metal film or graphite film, and therefore to a firmer connectivity to the textile fabric. In addition, a higher transverse strength is thereby achieved compared to that when smaller quantities of organic additive are added.

In principle, in this embodiment the molded body can also contain fillers along with the graphite and the organic additive, which however is not necessary and also not preferred. The molded body according to the invention according to this embodiment therefore preferably consists of the aforesaid quantity of organic additive and the remainder graphite.

In principle, any organic material can be used as organic additive. Good results are particularly obtained if the organic additive is a polymer selected from the group consisting of thermoplastics, thermosetting plastics, elastomers and any mixtures thereof. With such materials particularly at comparatively low temperatures of, for example, −100° C. to 300° C., a high impermeability of the molded body for liquid and gaseous substances is achieved.

Examples of suitable polymers are silicone resins, polyolefins, epoxide resins, phenol resins, melamine resins, urea resins, polyester resins, polyether etherketones, benzoxazines, polyurethanes, nitrile rubbers, such as acrylonitrile butadiene styrene rubber, polyamides, polyimides, polysulphones, polyvinylchloride and fluoropolymers such as polyvinylidene fluoride, ethylene tetrafluoroethylene copolymers and polytetrafluoroethylene and any mixture or copolymers of two or more of the aforesaid compounds.

According to a particularly preferred variant of this embodiment, the organic additive or the organic additives is or are selected from the group consisting of polyethylene, polypropylene, ethylene tetrafluoroethylene copolymers, polyvinylidene fluoride, polytetrafluoroethylene and any mixture of two or more of the aforesaid compounds. This has surprisingly proved particularly advantageous within the framework of the present invention for the balance of all the requisite properties such as high tensile strength, high electrical conductivity, good connectivity with graphite-based textile fabric, high thermal conductivity, high temperature resistance, good chemical resistance and high impermeability to liquids and gases.

In a further development of the inventive idea it is proposed that polyvinylidene fluoride should be provided as organic additive in the molded body of the layered composite material according to the invention. As a result of its thin liquid, polyvinylidene fluoride is particularly advantageous in the melt/sintering process and leads to a particularly good weldability with the textile fabric.

Consequently, the organic additive is preferably selected with respect to its chemical nature and quantity used such that the molded body is impermeable in a temperature range between −100 and 300° C. and in particular in a temperature range between −20 and 250° C. where impermeable is understood in the sense of the present invention such that the molded body has an impermeability perpendicular to its longitudinal plane of less than 10⁻¹ mg/(s.m²), preferably of less than 10⁻² mg/(s.m²) and particularly preferably of less than 10⁻³ mg/(s.m²), measured at a surface pressure of 20 MPA with helium as gas (1 bar helium test gas internal pressure) in a measuring apparatus based on DIN 28090-1 at room temperature.

According to a first quite particularly preferred embodiment of the present invention, the mixture to be compressed or the molded body provided in the layered composite material according to the invention contains 5 to 50 wt. % of polyethylene particles as organic additive. As a result a layered composite material is obtained which has the aforesaid properties, in particular low contact resistance and high impermeability of the molded body or the bipolar plate, in a particularly balanced manner. Good results are achieved in this embodiment if the mixture to be compressed or the molded body provided in the layered composite material according to the invention contains 10 to 30 wt. %, particularly preferably 15 to 25 wt. %, quite particularly preferably 18 to 22 wt. % and most preferably 20 wt. % of polyethylene particles. In addition to the polyethylene and the graphite, the molded body can also contain fillers which however is not necessary and also not preferred. The molded body according to the invention according to this embodiment therefore preferably consists of the aforesaid amount of polyethylene and the remainder expanded graphite.

According to a second quite particularly preferred embodiment of the present invention, the mixture to be compressed or the molded body provided in the layered composite material according to the invention contains 5 to 50 wt. % of polypropylene particles as organic additive. As a result a layered composite material is obtained which has the aforesaid properties, in particular low contact resistance and high impermeability of the molded body or the bipolar plate, in a particularly balanced manner. Good results are achieved in this embodiment if the mixture to be compressed or the molded body provided in the layered composite material according to the invention contains 5 to 40 wt. %, preferably 10 to 30 wt. %, particularly preferably 15 to 25 wt. %, quite particularly preferably 18 to 22 wt. % and most preferably 20 wt. % of polypropylene particles. In addition to the polypropylene and the graphite, the molded body can also contain fillers which however is not necessary and also not preferred. The molded body according to the invention according to this embodiment therefore preferably consists of the aforesaid amount of polyethylene and the remainder expanded graphite.

According to a third quite particularly preferred embodiment of the present invention, the mixture to be compressed or the molded body provided in the layered composite material according to the invention contains 0.5 to 30 wt. % of particles of an ethylene tetrafluoroethylene copolymer. As a result, layered composite materials having the aforesaid properties are surprisingly obtained. Good results are achieved in this embodiment if the mixture to be compressed or the molded body provided in the layered composite material according to the invention contains 1 to 20 wt. %, particularly preferably 3 to 10 wt. %, quite particularly preferably 5 to 8 wt. % and most preferably 6 wt. % of particles of an ethylene tetrafluoroethylene copolymer. In addition to the ethylene tetrafluoroethylene copolymer and the graphite, the molded body can also contain fillers which however is not necessary and also not preferred. The molded body according to the invention according to this embodiment therefore preferably consists of the aforesaid amount of ethylene tetrafluoroethylene copolymer and the remainder expanded graphite.

According to a fourth quite particularly preferred embodiment of the present invention, the mixture to be compressed or the molded body provided in the layered composite material according to the invention contains 0.5 to 50 wt. % of particles of polyvinylidene fluoride. As a result, layered composite materials having the aforesaid properties are obtained. Good results are achieved in this embodiment if the mixture to be compressed or the molded body provided in the layered composite material according to the invention contains 2 to 30 wt. %, particularly preferably 5 to 20 wt. %, quite particularly preferably 8 to 12 wt. % and most preferably 10 wt. % of particles of polyvinylidene fluoride. In addition to the polyvinylidene fluoride and the graphite, the molded body can also contain fillers which however is not necessary and also not preferred. The molded body according to the invention according to this embodiment therefore preferably consists of the aforesaid amount of polyvinylidene fluoride and the remainder expanded graphite.

In a further development of the inventive idea, it is proposed that the organic additive or the organic additives have a mean particle diameter (d₅₀) of 1 to 500 μm, preferably of 1 to 150 μm, particularly preferably of 2 to 30 μm and quite particularly preferably of 3 to 15 μm determined in accordance with ISO 13320.

It is further preferred that the graphite-containing molded body provided in the layered composite material according to the invention has a density of at least 1.0 g/cm³, preferably a density of 1.2 to 1.8 g/cm³ and particularly preferably a density of 1.4 to 1.7 g/cm³. As a result, particularly compact layered composite materials can be produced.

For the same reason it is preferred that the at least one graphite-containing molded body provided in the layered composite material according to the invention has a thickness of 0.02 to 3 mm, preferably of 0.2 to 1.0 mm and particularly preferably of 0.5 to 0.8 mm. In this case, the graphite-containing molded body is preferably formed as a film or plate. Thicker plates can be produced, for example, by pressing, adhesive bonding, welding, hot gluing of two individual molded bodies. This is possible with or without pressure and by using adhesives, adhesion promoters or by the additive present in the molded body. The direct weldability of two molded bodies is particularly preferred.

According to another preferred embodiment, the molded body provided in the layered composite material according to the invention is configured to be at least substantially flat and particularly preferably as a plate or film.

In principle, the at least one layer of textile fabric can have any textile structure. For example, the textile fabric can comprise a structure selected from the group consisting of woven fabrics, knitted fabrics, crocheted fabrics, papers, scrims, nonwovens, felts and any combination of two or more of the aforesaid structures.

In a further development of the inventive idea, it is proposed to provide the at least one layer of the textile fabric made of felt having a thickness of 1 to 20 mm, preferably of 1 to 10 mm and particularly preferably of 2 to 5 mm. Such textile fabrics are particularly well suited as electrode material for a redox flow battery. In particular in this embodiment, it is particularly preferred if the layered composite material according to the invention comprises two layers of textile fabric, particularly preferably felt, which are applied to the two outer surfaces of the graphite-containing molded body.

In principle, the textile fabric, preferably felt can be made of any material suitable for use as electrode in a redox flow battery. Merely as an example, mention is made in this context of textile fabric, preferably felts, made of carbon or graphite fibers, for example, based on cellulose, polyacrylonitrile or pitch as precursor. The textile fabric can however, also be made of other electrically good conducting material such as metal fibers.

According to another preferred embodiment of the present invention, the fibers of the textile fabric have a density of 1.2 to 2.0 g/cm³ and particularly preferably of 1.4 to 1.9 g/cm³. Such fibers have a suitable strength.

Good results when used in a redox flow battery are obtained in particular if the fibers forming the textile fabric and preferably the felt have a diameter of 5 to 20 μm and particularly preferably of 5 to 10 μm.

In order to achieve a good flow through the textile fabric with electrolytes usually used in redox flow batteries, in a further development of the inventive idea it is proposed that the textile fabric, preferably the felt, has a density of 0.001 to 0.5 g/cm³, preferably a density of 0.01 to 0.2 g/cm³ and quite particularly preferably a density of 0.08 to 0.12 g/cm³.

For the same reason, it is preferred alternatively or additionally to the aforesaid embodiment that the textile fabric, preferably the felt, has the highest possible specific BET surface area. Good results are obtained, for example, if the textile fabric, preferably the felt, has a specific BET surface area of 0.05 to 300 m²/g and preferably of 0.1 to 250 m²/g.

In order to achieve a sufficiently high electrical conductivity for use as electrode in redox flow batteries, the textile fabric, preferably felt, has an electrical resistivity of 1 to 15 Ω.mm and preferably of 3 to 4 Ω.mm or 10 to 12 Ω.mm measured in accordance with DIN 51911 at 20° C. and perpendicular to its longitudinal plane.

For the same reason it is preferred that the textile fabric, preferably felt, has an electrical resistivity of 0.5 to 3 Ω.mm and preferably of 1 to 2 Ω.mm measured in accordance with DIN 51911 at 20° C. and parallel to its longitudinal plane.

In the layered composite material according to the invention, the graphite-containing molded body with the textile fabric or fabrics, can be connected to one another directly, for example, thermally or by means of an adhesive.

For the thermal connection which is facilitated by the organic additive present in the molded body, for example, the individual layers can be melted and sintered on their connecting surfaces. This can be accomplished in the presence of, or in the absence of pressure.

Alternatively to this, the connection between the graphite-containing molded body and the textile fabric or fabrics can be made by using adhesive and/or adhesion promoters. In principle, any adhesive by which means two graphite-containing layers can be glued together is suitable for this. Good results are achieved in particular in this respect if a pitch, a phenol resin, a furan resin or a mixture of two or more of the aforesaid compounds is used such as, for example, an adhesive based on graphite-filled phenol resin or based on water glass. As a result of the organic additive contained in the molded body, this can be particularly firmly bonded to the layer or layers of textile fabric, preferably felt layers so that when using the layered composite material for example in a redox flow battery, a lower pressing must be carried out, for example, by a frame so that a better flow of electrolyte through the felt and therefore a better battery efficiency is achieved.

In order to achieve a low contact resistance, it is proposed in a further development of the inventive idea to use an electrically conductive adhesive. To this end, the adhesive, in particular pitch, phenol resin or furan resin can be mixed with suitable amounts of metal particles, in particular silver particles or nickel particles, carbon particles or graphite particles as filler.

A further subject matter of the present invention is a redox flow battery containing at least one layered composite material described previously, an electrolyte and a membrane. In particular, this can comprise a stack of several adjacent redox flow batteries or redox flow cells each connected by a previously described layered composite material.

In addition, the present invention relates to a bipolar plate, which is in particular suitable for use in a redox flow battery, where the bipolar plate can be obtained by a method in which graphite particles are mixed with at least one solid organic additive to form a mixture and the mixture thus obtained is then compressed.

According to a first particularly preferred embodiment of the present invention, the mixture to be compressed contains 5 to 50 wt. %, preferably 10 to 30 wt. %, particularly preferably 15 to 25 wt. %, quite particularly preferably 18 to 22 wt. % and most preferably about 20 wt. % of polyethylene particles. In addition to the polyethylene and the graphite, the molded body can also contain fillers but this is not necessary and is also not preferred. The molded body according to the invention according to this embodiment therefore preferably consists of the aforesaid amount of polyethylene and the remainder expanded graphite. In this embodiment in particular molded bodies having an electrical resistivity perpendicular to the longitudinal plane of the molded body of less than 15 Ohm.mm, having a tensile strength of 20 to 25 MPa and having an impermeability of less than 1. 10⁻³ mg/(s.m²) can be obtained.

In addition, according to a second particularly preferred embodiment of the present invention, the mixture to be compressed contains 5 to 50 wt. %, preferably 10 to 30 wt. %, particularly preferably 15 to 25 wt. %, quite particularly preferably 18 to 22 wt. % and most preferably about 20 wt. % of polypropylene particles. In addition to the polypropylene and the graphite, the molded body can also contain fillers but this is not necessary and is also not preferred. The molded body according to the invention according to this embodiment therefore preferably consists of the aforesaid amount of polypropylene and the remainder expanded graphite. In this embodiment in particular molded bodies having an electrical resistivity perpendicular to the longitudinal plane of the molded body of less than 15 Ohm.mm, having a tensile strength of 20 to 25 MPa and having an impermeability of less than 5. 10⁻³ mg/(s.m²) can be obtained.

According to a third particularly preferred embodiment of the present invention, the mixture to be compressed contains 0.5 to 30 wt. %, preferably 1 to 20 wt. %, particularly preferably 3 to 10 wt. %, quite particularly preferably 5 to 8 wt. % and most preferably about 6 wt. % of an ethylene tetrafluoroethylene copolymer. In addition to the ethylene tetrafluoroethylene copolymer and the graphite, the molded body can also contain fillers but this is not necessary and is also not preferred. The molded body according to the invention according to this embodiment therefore preferably consists of the aforesaid amount of ethylene tetrafluoroethylene copolymer and the remainder expanded graphite. In this embodiment in particular molded bodies having an electrical resistivity perpendicular to the longitudinal plane of the molded body of less than 15 Ohm.mm, having a tensile strength of 20 to 25 MPa and having an impermeability of less than 1. 10⁻³ mg/(s.m²) can be obtained.

Finally, according to a fourth particularly preferred embodiment of the present invention, the mixture to be compressed contains 0.5 to 50 wt. %, preferably 2 to 30 wt. %, particularly preferably 5 to 20 wt. %, quite particularly preferably 8 to 12 wt. % and most preferably about 10 wt. % of polyvinylidene fluoride particles. In addition to the polyvinylidene fluoride and the graphite, the molded body can also contain fillers but this is not necessary and is also not preferred. The molded body according to the invention according to this embodiment therefore preferably consists of the aforesaid amount of polyvinylidene fluoride and the remainder expanded graphite. In this embodiment in particular molded bodies having an electrical resistivity perpendicular to the longitudinal plane of the molded body of less than 15 Ohm.mm, having a tensile strength of 20 to 25 MPa and having an impermeability of less than 1. 10⁻³ mg/(s.m²) can be obtained.

A further subject matter of the present invention is the use of a layered composite material described previously or a previously described bipolar plate to produce a redox flow battery or a stack of several adjacent redox flow cells.

The present invention further relates to a method for producing a layered composite material described previously, which comprises the following steps:

a) mixing graphite particles with at least one solid organic additive to form a mixture,

b) compressing the mixture obtained in step a) in order to thus obtain a graphite-containing molded body,

c) preparing at least one layer of a textile fabric and

d) joining the at least one layer of a textile fabric prepared in step c) and the graphite-containing molded body obtained in step b).

The method according to the invention is preferably carried out continuously in order to thus produce the molded bodies according to the invention rapidly, easily and cost-effectively.

The continuous procedure of process steps a) and b) can be executed, for example, in a pipeline system in which the mixing according to process step a) is carried out such that a solid organic additive is fed, for example to a graphite-particle-containing gas stream by means of a screw conveyor and the gas stream containing mixed graphite particles and organic additive thus obtained is passed through a roller for compression according to process step b). Thus, not only the graphite particles and the additive can be mixed together rapidly and simply but in particular mixed gently, i.e. without major mechanical stressing so that any crushing and grinding of the solid particles during mixing, such as necessarily occurs when mixing in a static or dynamic agitator for several minutes or even hours, is avoided. This promotes the preceding advantageous properties of the molded body contained in the layered composite material according to the invention, primarily a high tensile strength and a high transverse strength.

In the method according to the invention, no mixing in a static or dynamic agitating device for more than 5 minutes, particularly for more than 20 minutes and in particular for more than 1 hour is therefore carried out before the compressing.

According to another preferred embodiment of the present invention, the mixture containing graphite particles and additive is melted and/or sintered during the compression or after the compression according to process step b). Within the framework of the present invention, it was surprisingly found that by this means the impermeability of the molded body to liquids and gases can be further increased. Without wishing to be bound to a theory, it is considered that the bonding of the graphite particles to the additive particles is improved by such melting or sintering and due to the thin thin-liquid additive, additional pores are closed and contact points produced.

A separate shaping step can be carried out for the final shaping in which the molded body is formed for example, by reforming, profiling, hot pressing, thermo-reforming, folding back, deep drawing, embossing or stamping.

In addition, the molded body can be heated in a mould whereby specific profiles, shapes, corrugations and/or embossings are produced. The additive stabilizes these shapes and prevents the back deformation known from conventional graphite films. The mechanical load-bearing capacity produced by the present invention allows such methods to be used for the first time.

The present invention is described hereinafter merely as an example with reference to advantageous embodiments and with reference to the appended drawings.

In the figures:

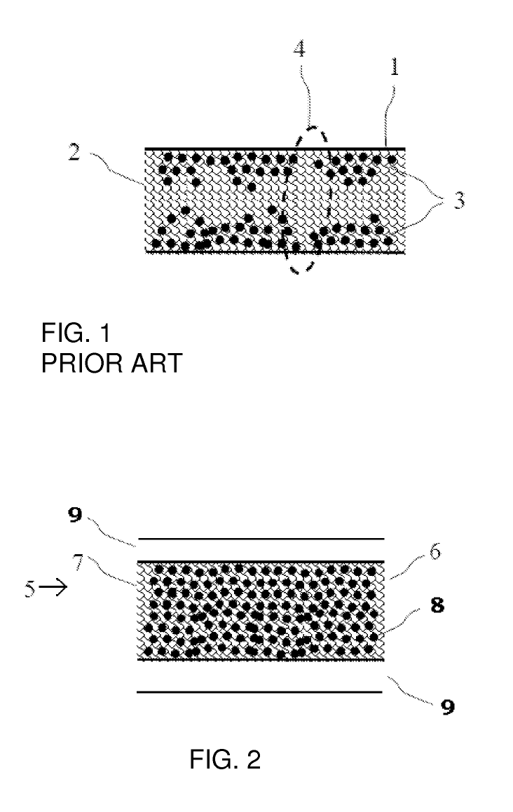

FIG. 1 shows a graphite-containing molded body according to the prior art and

FIG. 2 shows a layered composite material with a graphite-containing molded body according to one exemplary embodiment of the present invention.

FIG. 1 shows a schematic cross-section of a graphite-containing molded body 1 configured as a plate according to the prior art. This molded body 1 contains compressed, expanded graphite 2 and a liquid binder 3, where the binder 3 has been introduced subsequently into the molded body 1 by melt impregnation from the lateral surfaces of the molded body 1. As a result of introducing the binder 3 by melt impregnation, this has only penetrated non-uniformly and primarily superficially into the molded body 1 which is why particularly the inner region lying between the surface regions, such as for example, the region 4 lying in the oval dashed border contains only a little binder 3 or is almost binder-free. As a result, the properties of the molded body 1, in particular the mechanical strength and the tightness, of the molded body 1 vary primarily in the depth direction or z direction, where the inner region of the molded body 1 lying between the surface regions has a poorer tightness and inferior mechanical properties than the surface regions of the molded body 1.

The layered composite material 5 according to the present invention shown in FIG. 2 contains a molded body 6 which consists of particles 7 of expanded graphite configured in a known manner in a worm or concertina shape and of additive particles 8. Unlike the molded body 1 according to the prior art shown in FIG. 1, the additive particles 7 are distributed uniformly in all dimensions of the molded body 6 in the molded body 6 contained in the layered composite material 5 according to the invention and specifically in particular in the inner region of the molded body 6 lying between the surface regions. One layer of textile fabric or felt 9 is applied to each of the two outer surfaces of the molded body 6 and is joined to the molded body 6 by means of an adhesive (not shown).

In order to produce the molded body 6 contained in the layered composite material 5 shown in FIG. 2, the graphite particles 7 are firstly mixed homogeneously with the organic additive particles 8 before the mixture thus produced was compressed and formed into the desired shape.

The present invention is described further hereinafter with reference to examples which explain but do not restrict this invention.

### EXAMPLES

### Example 1

Expanded graphite having a bulk weight of 3.5 g/l was mixed with a polypropylene powder, i.e. with Licocene PP 2602 from Clariant, Germany to form a mixture containing 80 wt. % expanded graphite and 20 wt. % polypropylene powder and was then mixed in a container for 1 minute.

The mixture thus obtained was then transferred to a steel tube having a diameter of 90 mm, pressed by a pressure piston through its own body weight and removed as a preform having a density of about 0.07 g/cm³. The preform was then compressed with a press to the desired film thickness of 0.6 mm and the doped film thus obtained was conditioned at 180° C. for 60 minutes in order to melt the plastic.

The molded body thus obtained had an impermeability perpendicular to its longitudinal plane of 10⁻³ mg/(s.m²), measured at a surface pressure of 20 MPA with helium as gas (1 bar helium test gas internal pressure) in a measuring apparatus based on DIN 28090-1 at room temperature. This value and other properties of the molded body are summarized in Table 1 below.

The molded body was then adhesively bonded on one side to the graphite felt distributed under the trade name SIGRATHERM GFD5 by the company SGL Carbon GmbH. To this end the 0.6 mm molded body was cut to a size of 50×50 mm and then adhesive based on graphite-filled phenol resin distributed by SGL Carbon GmbH under the trade name V 58 a was applied to this by means of a spatula in an amount of 0.04 g/cm² of molded body before the graphite felt was then applied to the adhesive and the adhesive was then cured for 2 hours at 150° C. with an applied load of 2 kg.

For the layered composite material thus obtained, the electrical resistivity in the thickness direction was determined in accordance with DIN 51911 at 20° C., where a value of 7.7 Ohm mm was obtained. The results are summarized in the following Table 2.

As a result of using an electrically conducting adhesive, the layered composite material has a comparatively low electrical resistance. As a result of the addition of organic additive in the molded body or the bipolar plate, the bipolar plate has a high impermeability primarily to liquids without the organic additive disadvantageously influencing the electrical resistance of the layered composite material.

### Example 2

A layered composite material was produced according to the method described for Example 1 except that the molded body and the graphite felt were joined together without adhesive.

For the layered composite material thus obtained, the electrical resistivity in the thickness direction was determined in accordance with DIN 51911 at 20° C., where a value of 10.8 Ohm mm was obtained, that is, a somewhat higher electrical resistance than that for the layered composite material according to Example 1 in which a conductive adhesive was used. The results are summarized in the following Table 2.

### Example 3

A layered composite material was produced according to the method described for Example 1 except that the molded body and the graphite felt were joined together without adhesive. Rather, the felt body was placed on the molded body and contacted for hours at 180° C. with an applied load of 2 kg. The melting of the additive present in the bipolar plate resulted in a direct adhesive bonding or welding of the graphite-containing molded body and the felt body.

For the layered composite material thus obtained, the electrical resistivity in the thickness direction was determined in accordance with DIN 51911 at 20° C., where a value similar to that for the layered composite material according to Example 2 was obtained.

### Comparative Example 1

A molded body in the form of a graphite film was produced according to the method described for Example 1 except that only expanded graphite was used for its manufacture and no additive.

The molded body thus obtained had an impermeability perpendicular to its longitudinal plane of 1.10⁻² mg/(s.m²) measured at a surface pressure of 20 MPa with helium as gas (1 bar helium test gas internal pressure) in a measuring apparatus based on DIN 28090-1 at room temperature. This value together with other properties of the molded body are summarized in the following Table 1.

A layered composite material produced from this molded body as described in Example 1 had a similar electrical resistivity in the thickness direction as the composite material of Example 3.

TABLE 1
Properties of the molded body

| | Thickness | Density of | |
|---|---|---|---|
| | of film | film | Impermeability/leakage |
| Sample | [mm] | [g/cm³] | [mg/(s · m²)] |
| Example 1 | 0.6 | 1.7 | 1 · 10⁻³ |
| Comparative | 0.6 | 1.7 | 1 · 10⁻² |
| example 1 | | | |

TABLE 2
Properties of the layered composite material

| | Electrical resistivity in the |
|---|---|
| Sample | thickness direction [Ohm mm] |
| Example 1 | 7.7 |
| Example 2 | 10.8 |

These examples show that the addition of organic additive to the molded body or the bipolar plate of the layered composite material increases the impermeability of the bipolar plate without significantly negatively influencing the electrical resistivity of the layered composite material in the thickness direction.

### REFERENCE LIST

1 Molded body according to the prior art
2 (Expanded) graphite
3 Binder
4 Region of the molded body
5 Layered composite material according to the present invention
6 Graphite-containing molded body
7 Particle of (expanded) graphite
8 Additive particle
9 Textile fabric or felt

1-21. (canceled)

22. A layered composite material, comprising:
at least one layer of textile fabric; and
at least one graphite-containing molded body, said graphite-containing molded body having graphite particles mixed with at least one solid organic additive to form a mixture and the mixture obtained then being compressed.

23. The layered composite material according to claim 22, wherein said graphite particles, said at least one solid organic additive and said mixture produced therefrom are not melted and not sintered before compressing.

24. The layered composite material according to claim 22, wherein when producing said graphite-containing molded body, said graphite particles being particles of expanded graphite produced from natural graphite and having a mean particle diameter of at least 149 μm determined in accordance with a measurement method and screen set specified in DIN 66165.

25. The layered composite material according to claim 23, wherein said particles of expanded graphite have a bulk weight of 0.5 to 95 g/l.

26. The layered composite material according to claim 22, wherein said graphite-containing molded body has an impermeability perpendicular to its longitudinal plane of less than 10⁻¹ mg/(s.m²) measured at a surface pressure of 20 MPA with helium as a gas at 1 bar helium test gas internal pressure in a measuring apparatus based on DIN 28090-1 at room temperature.

27. The layered composite material according to claim 22, wherein said graphite-containing molded body has a tensile strength of 10 to 35 MPa measured in accordance with DIN ISO 1924-2.

28. The layered composite material according to claim 22, wherein said graphite-containing molded body has an electrical resistivity of less than 20 Ω.mm measured in accordance with DIN 51911 with an applied load of 50 N in an area of 50 mm perpendicular to its longitudinal plane.

29. The layered composite material according to claim 24, wherein said mixture to be compressed contains 1 to 50 wt. % of said at least one solid organic additive.

30. The layered composite material according to claim 29, wherein said mixture to be compressed contains as said solid organic additive at least one polymer selected from the group consisting of polyethylene, polypropylene, ethylene tetrafluoroethylene copolymers, polyvinylidene fluoride, polytetrafluoroethylene, and any mixture of at least two of the aforesaid compounds.

31. The layered composite material according to claim 30, wherein said mixture to be compressed contains 0.5 to 50 wt. % of polyvinylidene fluoride particles and a remainder being said particles of expanded graphite.

32. The layered composite material according to claim 22, wherein when producing said graphite-containing molded body, said solid organic additive having a mean particle diameter of 1 to 500 μm determined in accordance with ISO 13320 are used.

33. The layered composite material according to claim 22, wherein said at least one graphite-containing molded body has a density of at least 1.0 g/cm³.

34. The layered composite material according to claim 22, wherein said at least one graphite-containing molded body has a thickness of 0.02 to 3 mm.

35. The layered composite material according to claim 22, wherein said at least one layer of textile fabric is selected from the group consisting of woven fabrics, knitted fabrics, crocheted fabrics, papers, scrims, nonwovens, felts and any combination of at least two of the aforesaid structures.

36. The layered composite material according to claim 22, wherein said at least one layer of textile fabric contains carbon or graphite fibers including being constructed therefrom.

37. The layered composite material according to claim 22, wherein said at least one layer of textile fabric and said at least one graphite-containing molded body are connected to one another directly or by means of an adhesive.

38. The layered composite material according to claim 37, wherein said at least one layer of textile fabric and said at least one graphite-containing molded body are connected to one another by means of an adhesive, wherein said adhesive is selected from the group consisting of pitch, a phenol resin, a furan resin and a mixture of at least two of the aforesaid compounds.

39. The layered composite material according to claim 22, wherein the layered composite material is for use in a redox flow battery.

40. The layered composite material according to claim 22, wherein when producing said graphite-containing molded body, said graphite particles being particles of expanded graphite produced from natural graphite having a mean particle diameter of at least 180 μm determined in accordance with a measurement method and screen set specified in DIN 66165.

41. The layered composite material according to claim 23, wherein said particles of said expanded graphite have a bulk weight of 2 to 10 g/l.

42. The layered composite material according to claim 22, wherein said graphite-containing molded body has an impermeability perpendicular to its longitudinal plane of less than 10⁻³ mg/(s.m²) measured at a surface pressure of 20 MPA with helium as a gas at 1 bar helium test gas internal pressure in a measuring apparatus based on DIN 28090-1 at room temperature.

43. The layered composite material according to claim 22, wherein said graphite-containing molded body has an electrical resistivity of less than 15 Ω.mm measured in accordance with DIN 51911 with an applied load of 50 N in an area of 50 mm perpendicular to its longitudinal plane.

44. The layered composite material according to claim 24, wherein said mixture to be compressed contains 5 to 25 wt. % of said at least one solid organic additive.

45. The layered composite material according to claim 30, wherein said mixture to be compressed contains 10 wt. % of polyvinylidene fluoride particles and remainder being said particles of said expanded graphite.

46. The layered composite material according to claim 22, wherein when producing said graphite-containing molded body, said solid organic additive having a mean particle diameter of 3 to 15 μm determined in accordance with ISO 13320 are used.

47. The layered composite material according to claim 22, wherein said at least one graphite-containing molded body has a density of at least 1.4 to 1.7 g/cm³.

48. The layered composite material according to claim 22, wherein said at least one graphite-containing molded body has a thickness of 0.5 to 0.8 mm.

49. The layered composite material according to claim 38, further comprising metal particles selected from the group consisting of silver particles, nickel particles, carbon particles and graphite particles being a filler and mixed in said adhesive.

50. A redox flow battery, comprising:
a layered composite material containing at least one layer of textile fabric and at least one graphite-containing molded body, said graphite-containing molded body having graphite particles mixed with at least one solid organic additive to form a mixture and the mixture obtained then being compressed;
an electrolyte; and
a membrane.

51. A bipolar plate for use in a redox flow battery, the bipolar plate comprising:
at least one solid organic additive; and
graphite particles mixed with said at least one solid organic additive forming a mixture and said mixture being compressed, said mixture to be compressed containing 0.5 to 50 wt. % of said solid organic additive and a remainder being said graphite particles being particles of expanded graphite.

52. The bipolar plate according to claim 51, wherein said mixture to be compressed containing 5 to 20 wt. % of said solid organic additive and a remainder being said particles of expanded graphite.

53. A production method, which comprises the steps of:
providing a layered composite material containing at least one layer of textile fabric and at least one graphite-containing molded body, the graphite-containing molded body having graphite particles mixed with at least one solid organic additive to form a mixture and the mixture obtained being compressed; and
producing a redox flow battery or a stack of several adjacent redox flow cells from the layered composite material.

54. A production method, which comprises the steps of:
providing a bipolar plate containing at least one solid organic additive and graphite particles mixed with the at least one solid organic additive forming a mixture and the mixture being compressed, the mixture to be compressed containing 0.5 to 50 wt. % of the solid organic additive and a remainder being said graphite particles being particles of expanded graphite; and
producing a redox flow battery or a stack of several adjacent redox flow cells from the bipolar plate.

55. A method for producing a layered composite material, which comprises the following steps of:
mixing graphite particles with at least one solid organic additive to form a mixture;
compressing the mixture for obtaining a graphite-containing molded body;
preparing at least one layer of a textile fabric; and
joining the at least one layer of a textile fabric and the graphite-containing molded body.
